(19) United States
(12) Patent Application Publication
(10) Pub. No.: US 2020/0346226 A1
(43) Pub. Date: Nov. 5, 2020

(54) NOZZLE UNIT

(71) Applicant: IHI Corporation, Tokyo (JP)

(72) Inventors: Akira Sadaki, Tokyo (JP); Jun Maeno, Tokyo (JP); Akito Yamasaki, Tokyo (JP); Tsukasa Nakane, Tokyo (JP); Yuichi Takahama, Tokyo (JP)

(73) Assignee: IHI Corporation, Tokyo (JP)

(21) Appl. No.: 16/930,023

(22) Filed: Jul. 15, 2020

Related U.S. Application Data
(63) Continuation of application No. PCT/JP2018/040284, filed on Oct. 30, 2018.

(30) Foreign Application Priority Data
Jan. 18, 2018 (JP) 2018-006624

(51) Int. Cl. B05B 1/06; B24C 1/00; B24C 5/04

(52) U.S. Cl. CPC B05B 1/06; B05B 9/0403; B24C 5/04; B24C 1/003

(57) ABSTRACT

A nozzle unit is configured to inject a liquefied fluid which evaporates after injection, and includes a tubular portion which has a base portion and a distal end portion and in which a flow path configured to guide the liquefied fluid to a part including the distal end portion and the base portion is formed, the distal end portion having an injection opening and being bent or curved and connected to the base portion.

### CROSS-REFERENCE TO RELATED APPLICATIONS

This application is a Continuation application based on International Application No. PCT/JP2018/040284, filed Oct. 30, 2018, which claims priority on Japanese Patent Application No. 2018-006624, filed Jan. 18, 2018, the contents of which are incorporated herein by reference.

### TECHNICAL FIELD

The present disclosure relates to a nozzle unit.

### BACKGROUND

For example, Patent Document 1 discloses a method for processing or cleaning an object by injecting liquid nitrogen instead of water. In a water jet method using water, since cutting pieces or the like and dirt are mixed with water, it is necessary to consider the treatment of water itself, and a large amount of secondary waste may be generated. On the other hand, in the case of using liquid nitrogen that evaporates after injection, since liquid nitrogen is separated and vaporized from cutting pieces and dirt, processing and cleaning can be performed without generating secondary waste.

### Document of Related Art

### Patent Document

[Patent Document 1] U.S. Pat. No. 7,310,955

### SUMMARY

When using a liquefied fluid that evaporates and expands after injection such as liquid nitrogen or the like, an object is destroyed by an expansion force of the liquefied fluid. For this reason, when the object is, for example, a concrete structure including inclusions such as reinforcing bars and pipes into which the liquefied fluid does not enter, it is possible to easily process or remove only the concrete portion into which the liquefied fluid permeates, without damaging the inclusions. For this reason, it is conceivable to perform drilling or the like of a concrete structure without damaging the inclusions, by injection of a vaporizable liquefied fluid such as liquid nitrogen.

However, in Patent Document 1, liquid nitrogen is injected from a straight tubular nozzle unit. For this reason, when the drilling of the concrete structure advances and the nozzle unit is made to enter the inside of the concrete structure, the nozzle unit cannot be tilted, and liquid nitrogen can be injected only in front of the nozzle unit. For this reason, it is difficult to enlarge a diameter of a hole, and only a hole corresponding to the diameter of the nozzle unit can be formed. Further, when the nozzle unit hits inclusions during drilling, the nozzle unit cannot be advanced while avoiding the inclusions. That is, the nozzle unit disclosed in Patent Document 1 does not have a shape suitable for processing a porous structure including inclusions such as a reinforcing bar.

The present disclosure has been made in view of the above-described problems, and an object thereof is to enable processing of a porous structure including inclusions such as a reinforcing bar or a pipe to be easily performed by a nozzle unit that injects a liquefied fluid that evaporates after injection.

According to an aspect of the present disclosure, there is provided a nozzle unit which is configured to inject a liquefied fluid which evaporates after injection, and includes a tubular portion which has a base portion and a distal end portion and in which a flow path configured to guide the liquefied fluid to a part including the distal end portion and the base portion is formed, the distal end portion having an injection opening and being bent or curved and connected to the base portion.

In the nozzle unit according to the aspect, the base portion may be formed in a straight tube shape, and the distal end portion may be configured to inject the liquefied fluid in a direction inclined with respect to an axis of the base portion.

In the nozzle unit according to the aspect, the injection opening of the distal end portion may open toward a side opposite to the base portion.

In the nozzle unit of the aspect, the nozzle unit may further include a heat insulating portion which is fixed to the tubular portion and surrounds the flow path from a radially outer side.

In the nozzle unit according to the aspect, the heat insulating portion may cover the tubular portion from the radially outer side, and is capable of being divided in an extending direction of the tubular portion.

The nozzle unit according to the aspect of the invention may further include a gripping portion which is attached to the tubular portion and protrudes to a radially outer side from the tubular portion.

In the nozzle unit according to the aspect, the gripping portion may include a plurality of gripping portions which are provided on the base portion to be spaced apart from each other in an extending direction of the flow path.

In the nozzle unit according to the aspect, the plurality of gripping portions may protrude in different directions around the tubular portion.

In the nozzle unit according to the aspect, the gripping portion may be attached to be movable in an extending direction of the tubular portion.

According to the present disclosure, the tubular portion has a distal end portion that is bent or curved and connected to the base portion, and the distal end portion has an injection opening. For this reason, by rotating the base portion, the injection opening can be moved in a circumferential direction when viewed from the base portion side, and an inner wall surface of a hole can be scraped without tilting the tubular portion, and the diameter of the hole can be easily enlarged. In addition, since the tubular portion can be tilted by enlarging the diameter of the hole, even when the distal end portion of the tubular portion hits inclusions, the inclusions can be easily avoided by performing tilting or the like of the tubular portion. Therefore, according to the present disclosure, by using the nozzle unit that injects a liquefied fluid that evaporates after injection, it is possible to easily process a porous structure including inclusions such as a reinforcing bar or a pipe.

### BRIEF DESCRIPTION OF DRAWINGS

FIG. 1 is a schematic diagram showing a schematic configuration of a liquid nitrogen injection system equipped with a nozzle unit according to a first embodiment of the present disclosure.

FIG. 2 is an enlarged perspective view showing a schematic configuration of the nozzle unit according to the first embodiment of the present disclosure.

FIG. 3 is an enlarged perspective view showing a schematic configuration of a nozzle unit according to a second embodiment of the present disclosure.

FIG. 4 is an enlarged perspective view showing a schematic configuration of a gripping portion provided in the nozzle unit according to the second embodiment of the present disclosure.

FIG. 5 is an enlarged perspective view showing a schematic configuration of a gripping portion provided in a modified example of the nozzle unit according to the second embodiment of the present disclosure.

FIG. 6 is an enlarged perspective view showing a schematic configuration of the gripping portion provided in the modified example of the nozzle unit according to the second embodiment of the present disclosure.

FIG. 7 is an enlarged perspective view showing a schematic configuration of a gripping portion provided in a modified example of the nozzle unit according to the second embodiment of the present disclosure.

FIG. 8 is an enlarged perspective view showing a schematic configuration of a nozzle unit according to a third embodiment of the present disclosure.

FIG. 9 is a partially enlarged perspective view showing a schematic configuration of a heat insulating unit provided in the nozzle unit according to a third embodiment of the present disclosure.

### DESCRIPTION OF EMBODIMENTS

Hereinafter, an embodiment of a nozzle unit according to the present disclosure will be described with reference to the drawings.

### First Embodiment

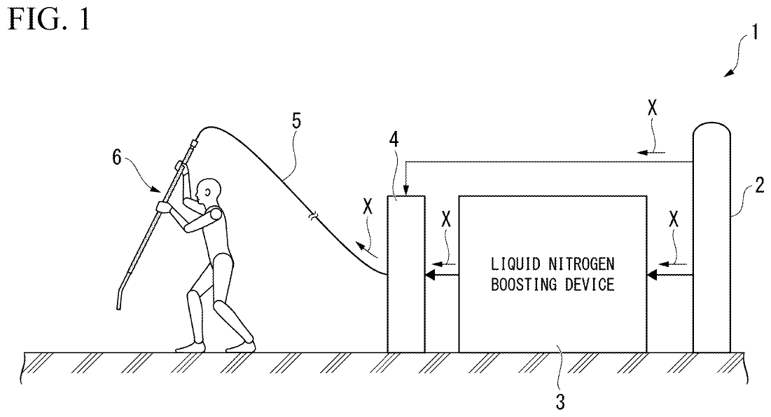

FIG. 1 is a schematic diagram showing a schematic configuration of a liquid nitrogen injection system 1 equipped with the nozzle unit of the present embodiment. As shown in FIG. 1, the liquid nitrogen injection system 1 is equipped with a storage tank 2, a liquid nitrogen boosting device 3, a chiller 4, a flexible hose 5, and a nozzle unit 6.

The storage tank 2 is a pressure tank which stores a liquid nitrogen X, and is connected to the liquid nitrogen boosting device 3 and the chiller 4. Note that the liquid nitrogen injection system 1 may be configured to receive the supply of the liquid nitrogen X from outside, without including the storage tank 2.

The liquid nitrogen boosting device 3 boosts the liquid nitrogen X, which is supplied from the storage tank 2, to a predetermined injection pressure. For example, the liquid nitrogen boosting device 3 is equipped with a boost pump for pumping the liquid nitrogen X, a pre-pump for primarily boosting the liquid nitrogen X sent from the boost pump, an intensifier pump for secondarily boosting the primarily-boosted liquid nitrogen X up to the injection pressure, and the like. The liquid nitrogen boosting device 3 is connected to the chiller 4.

The chiller 4 is a heat exchanger which cools the boosted liquid nitrogen X to an injection temperature, by performing a heat exchange between the liquid nitrogen X heated by being boosted with the liquid nitrogen boosting device 3 and the liquid nitrogen X supplied from the storage tank 2. One end of the flexible hose 5 is connected to the chiller 4.

For example, the liquid nitrogen boosting device 3 and the chiller 4 are unitized and disposed on a single mobile carrier. Since the liquid nitrogen boosting device 3 and the chiller 4 which are unitized, and the storage tank 2 as necessary are disposed in the mobile carrier, the liquid nitrogen injection system 1 can be easily moved. The liquid nitrogen boosting device 3 and the chiller 4 do not necessarily need to be unitized. For example, the liquid nitrogen boosting device 3 and the chiller 4 may be disposed separately, and the chiller 4 may be disposed near the nozzle unit 6. Accordingly, it is possible to suppress the temperature of the liquid nitrogen X, which has been cooled by the chiller 4, from rising before the liquid nitrogen X reaches the nozzle unit 6 and to enhance a jet force of the liquid nitrogen X injected from the nozzle unit 6.

The flexible hose 5 is a hose with flexibility having one end connected to the chiller 4 and the other end connected to the nozzle unit 6. The flexible hose 5 guides the boosted liquid nitrogen X from the chiller 4 to the nozzle unit 6. The flexible hose 5 has pressure resistance and heat insulation, and guides the liquid nitrogen X, which is supplied from the chiller 4, to the nozzle unit 6, while suppressing a decrease in pressure and temperature to a minimum.

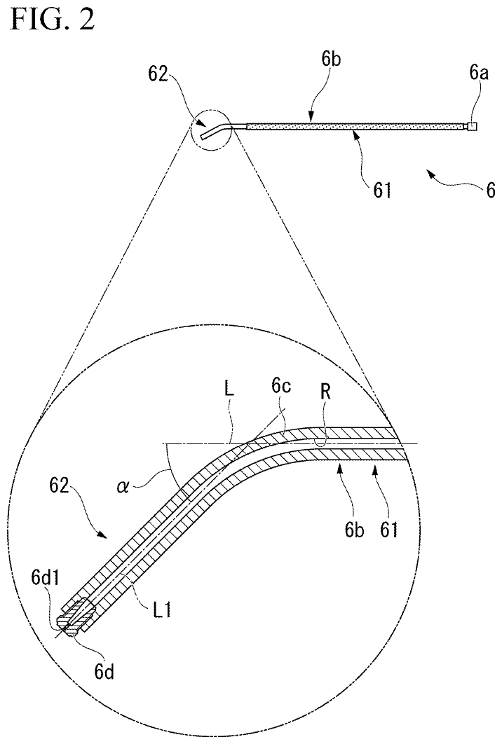

FIG. 2 is an enlarged perspective view showing a schematic configuration of the nozzle unit 6. As shown in FIG. 2, the nozzle unit 6 is equipped with a connecting portion 6a and a tubular portion 6b. The flexible hose 5 is connected to the connecting portion 6a. A flow path (not shown) is formed inside the connecting portion 6a.

The tubular portion 6b includes a cylindrical trunk portion 6c having a flow path R formed therein, and an orifice portion 6d fixed to the distal end portion of the trunk portion 6c. The trunk portion 6c is, for example, a long pipe-shaped part that is heat-insulated, and guides the liquid nitrogen X from the connecting portion 6a to the orifice portion 6d through the flow path R formed therein along a longitudinal direction thereof. The trunk portion 6c is gripped by an operator when injecting the liquid nitrogen X onto the object. The orifice portion 6d is fixed to the distal end of the trunk portion 6c, and has an injection opening 6d1 for injecting the liquid nitrogen X forward. The injection opening 6d1 is connected to the flow path R of the trunk portion 6c, and the liquid nitrogen X flowing through the flow path R is injected from the injection opening 6d1 to the outside of the tubular portion 6b.

The tubular portion 6b has a straight tubular base portion 61 and a distal end portion 62 including the orifice portion 6d. The base portion 61 is a part on a base side (the connecting portion 6a side) of the trunk portion 6c, and extends linearly along a linear axis L. The distal end portion 62 includes the injection opening 6d1 by having the orifice portion 6d, and injects the liquid nitrogen X. As shown in FIG. 2, the distal end portion 62 is curved and connected to the base portion 61 such that the injection opening 6d1 is opened toward an opposite side of the base portion 61, and an injection direction of the liquid nitrogen X is inclined with respect to the axis L of the base portion 61. More specifically, a part of the distal end portion 62 on the base portion 61 side is curved with a constant radius of curvature, a part of the distal end portion 62 on the injection opening 6d1 side has a linear shape, and the part of the distal end portion 62 on the base portion 61 side and the part on the injection opening 6d1 side are integrally connected so that an axis L1 of the distal end portion 62 on the injection opening 6d1 side forms an angle α smaller than 90° (about 45° in the present embodiment) with respect to the axis L of the base portion 61.

The nozzle unit 6 of the present embodiment has the tubular portion 6b in which the distal end portion 62 having the injection opening 6d1 is curved and connected to the base portion 61 and which has the flow path R which guides the liquid nitrogen X to the base portion 61 and the distal end portion 62. Further, the tubular portion 6b has the base portion 61 set to have a straight tube shape, and the distal end portion 62 which injects the liquid nitrogen X in a direction inclined with respect to the axis L of the base portion 61.

In the liquid nitrogen injection system 1 including the nozzle unit 6 of the present embodiment, the liquid nitrogen X is supplied from the storage tank 2 to the liquid nitrogen boosting device 3. The liquid nitrogen X is boosted to the injection pressure by the liquid nitrogen boosting device 3 and then is supplied to the chiller 4. The liquid nitrogen X supplied from the liquid nitrogen boosting device 3 to the chiller 4 is cooled by exchanging heat with the liquid nitrogen X supplied from the storage tank 2 to the chiller 4 through another route. The liquid nitrogen X cooled by the chiller 4 is supplied to the nozzle unit 6 via the flexible hose 5. The liquid nitrogen X supplied to the nozzle unit 6 flows through the flow path R inside the tubular portion 6b, and is injected to the outside from the injection opening 6d1.

According to the nozzle unit 6 of the present embodiment, the tubular portion 6b includes the distal end portion 62 that is curved and connected to the base portion 61, and the distal end portion 62 has the injection opening 6d1. For this reason, for example, by rotating the base portion 61 about the axis L, the injection opening 6d1 can be moved in the circumferential direction when viewed from the base portion 61 side, an inner wall surface of a hole can be scraped without tilting the tubular portion 6b, and the diameter of the hole can be easily enlarged. In addition, since the tubular portion 6b can be tilted by enlarging the diameter of the hole, even when the distal end portion of the tubular portion 6b hits inclusions such as a reinforcing bar or a pipe, the inclusions can be easily avoided, by performing tilting or the like of the tubular portion 6b. Therefore, according to the nozzle unit 6 of the present embodiment, it is possible to easily perform processing of a porous structure (for example, a concrete structure) including inclusions such as a reinforcing bar or a pipe by the nozzle unit that injects the liquid nitrogen X that evaporates after the injection.

Further, in the nozzle unit 6 of the present embodiment, the tubular portion 6b has the base portion 61 set to have a straight tube shape, and the distal end portion 62 which injects the liquid nitrogen X in a direction inclined with respect to the axis L of the base portion 61. For this reason, by rotating the straight tubular base portion 61 about the axis L, the injection direction of the liquid nitrogen X can be easily changed in the circumferential direction, and the injection direction of the liquid nitrogen X can be changed with the minimum necessary operation.

In addition, in the nozzle unit 6 of the present embodiment, the injection opening 6d1 of the distal end portion 62 is opened toward the side opposite to the base portion 61. For example, it is also possible to tilt the injection opening 6d1 with respect to the axis L and direct the injection opening 6d1 toward the base portion 61 side. However, by directing the injection opening 6d1 toward the side opposite to the base portion 61, concrete or the like in front of the nozzle unit 6 can be easily destroyed, and therefore the nozzle unit 6 can be suitably used for drilling a concrete structure or the like.

### Second Embodiment

Next, a second embodiment of the present disclosure will be described. In the second embodiment, description of parts the same as those in the first embodiment will be omitted or simplified.

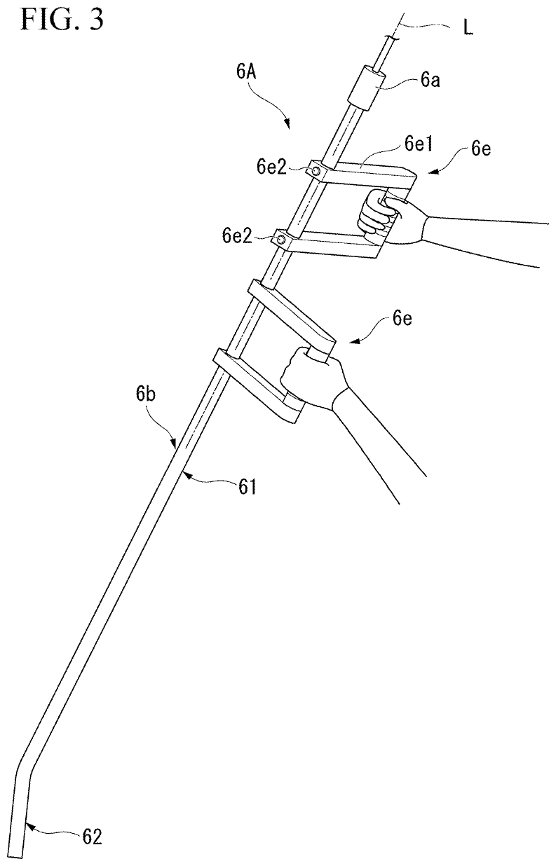

FIG. 3 is an enlarged perspective view showing a schematic configuration of a nozzle unit 6A of the present embodiment. As shown in FIG. 3, the nozzle unit 6A of the present embodiment is equipped with gripping portions 6e, in addition to the configuration of the nozzle unit 6 of the first embodiment.

The gripping portion 6e is attached to the tubular portion 6b and protrudes from the tubular portion 6b to a radially outer side of the tubular portion 6b. As shown in FIG. 3, the gripping portion 6e is attached to the base portion 61 (a linear portion) of the tubular portion 6b. A plurality (two in the present embodiment) of gripping portions 6e are provided apart from each other in an extending direction of the base portion 61 (an extending direction of the flow path R in the base portion 61).

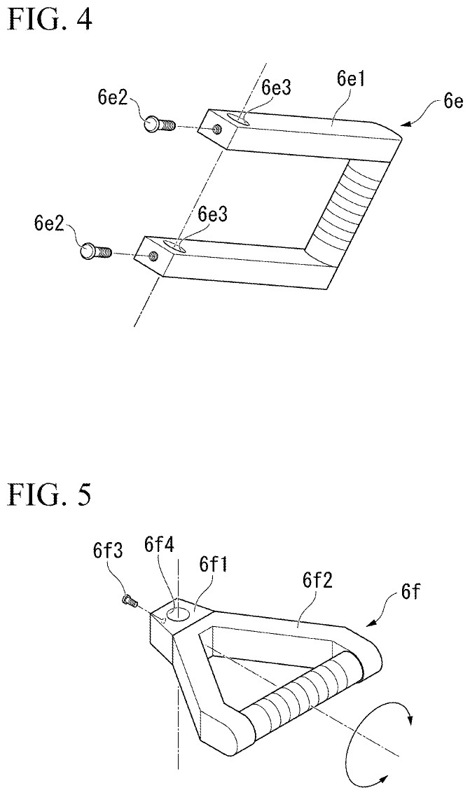

FIG. 4 is an enlarged perspective view showing a schematic configuration of the gripping portion 6e. As shown in FIG. 4, the gripping portion 6e includes a main body portion 6e1 and lock portions 6e2. As shown in FIG. 4, the main body portion 6e1 is a substantially C-shaped portion, and penetration holes 6e3 are formed at both end portions of the main body portion 6e1 to be concentric with each other. A diameter of the penetration hole 6e3 is slightly larger than an outer diameter of the base portion 61 of the tubular portion 6b, and the base portion 61 is inserted through the penetration holes 6e3. Further, a screw hole into which the lock portion 6e2 is screwed is formed at each end portion of the main body portion 6e1. Each screw hole is connected to the respective penetration hole 6e3 from the radially outer side of the penetration hole 6e3. Thus, the distal end portion of the lock portion 6e2 screwed into the screw hole can be brought into contact with the tubular portion 6b inserted through the penetration holes 6e3.

The lock portion 6e2 is a screw part screwed into the aforementioned screw hole provided in the main body portion 6e1, and is moved in a direction along an axis thereof (a radial direction of the base portion 61 of the tubular portion 6b) by being rotated about the axis. As the lock portion 6e2 is rotated in a tightening direction (a direction in which the lock portion 6e2 moves to the radially inner side of the base portion 61 of the tubular portion 6b), the distal end portion of the lock portion 6e2 comes into contact with the base portion 61 of the tubular portion 6b to regulate the movement of the main body portion 6e1 with respect to the base portion 61 by the frictional force.

The gripping portion 6e can be moved along the extending direction (the longitudinal direction) of the base portion 61 of the tubular portion 6b by loosening the lock portion 6e2. Further, the gripping portion 6e is fixed to the tubular portion 6b by tightening the lock portion 6e2.

As shown in FIG. 3, it is preferable to fix the gripping portion 6e disposed on the distal end side of the tubular portion 6b and the gripping portion 6e disposed on the connecting portion 6a side to protrude in different directions about the tubular portion 6b. Accordingly, for example, the gripping portion 6e disposed on the distal end side of the tubular portion 6b can be made to protrude to a left hand side of the operator, and the gripping portion 6e disposed on the connecting portion 6a side can be made to protrude to a right hand side of the operator.

The nozzle unit 6A of the present embodiment is equipped with the gripping portion 6e attached to the tubular portion 6b and protruding radially outward from the tubular portion 6b. For this reason, the operator can operate the nozzle unit 6A by gripping the gripping portion 6e, and the operability of the nozzle unit 6A can be improved.

In addition, in the nozzle unit 6A of the present embodiment, the plurality of gripping portions 6e are provided apart from each other in the extending direction of the flow path R on the base portion 61 of the tubular portion 6b. For this reason, the operator can stably hold the nozzle unit 6A with both hands, and the workability can be improved.

In addition, in the nozzle unit 6A of the present embodiment, the two gripping portions 6e protrude in different directions around the tubular portion 6b. For this reason, for example, the operator can grip the nozzle unit 6A with both left and right hands from both sides, and the workability can be further improved.

Further, in the nozzle unit 6A of the present embodiment, the gripping portion 6e is attached to be movable in the extending direction of the tubular portion 6b. For this reason, the position of the gripping portion 6e can be adjusted depending on the working position and the physique of the operator, and the workability can be further improved.

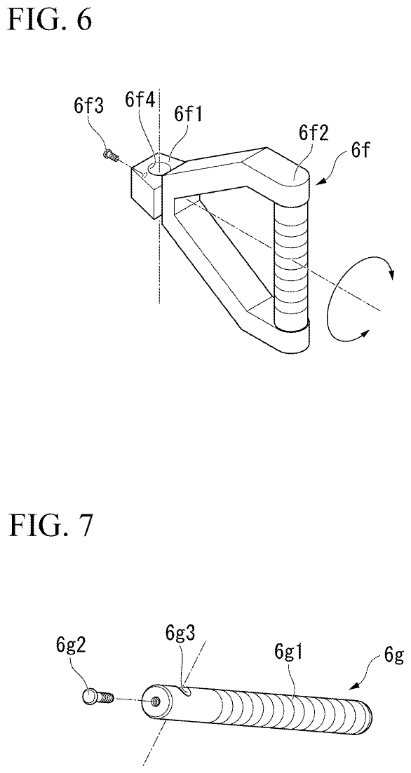

Further, as shown in FIGS. 5 and 6, the main body portion 6f2 may include a rotatable gripping portion 6f instead of the gripping portion 6e. The gripping portion 6f shown in FIGS. 5 and 6 includes a support portion 6f1, a main body portion 6f2, and a lock portion 6f3.

The support portion 6f1 has a penetration hole 6f4 having a diameter slightly larger than the outer diameter of the base portion 61 of the tubular portion 6b, and the base portion 61 is inserted through the penetration hole 6f4. The support portion 6f1 rotatably supports the main body portion 6f2, as shown in FIGS. 5 and 6. Further, the support portion 6f1 has a screw hole into which the lock portion 6f3 is screwed. The screw hole is connected to the penetration hole 6f4 from the radially outer side of the penetration hole 6f4. As a result, the distal end portion of the lock portion 6f3 screwed into the screw hole can be brought into contact with the tubular portion 6b inserted into the penetration hole 6f4.

The main body portion 6f2 is a substantially triangular annular portion, and one of the apexes thereof is rotatably connected to the support portion 6f1. In the present embodiment, the main body portion 6f2 is rotatable about a rotation axis orthogonal to the axis L (see FIG. 2) of the base portion 61 of the tubular portion 6b.

The lock portion 6f3 is a screw portion screwed into the aforementioned screw hole provided in the support portion 6f1, and is moved in a direction along an axis thereof (the radial direction of the base portion 61 of the tubular portion 6b) by being rotated about the axis. As the lock portion 6f3 is rotated in a tightening direction (a direction in which the lock portion 6f3 moves to the radially inner side of the base portion 61 of the tubular portion 6b), the distal end portion of the lock portion 6f3 comes into contact with the base portion 61 of the tubular portion 6b to regulate the movement of the main body portion 6f2 with respect to the base portion 61 by the frictional force.

The gripping portion 6f can be moved along the extending direction (the longitudinal direction) of the base portion 61 of the tubular portion 6b by loosening the lock portion 6f3. Further, the gripping portion 6f is fixed to the tubular portion 6b by tightening the lock portion 6f3.

According to the gripping portion 6f, since the main body portion 6f2 is rotatable with respect to the support portion 6f1, the operator can arbitrarily adjust a rotation angle of the main body portion 6f2 with respect to the support portion 6f1, and the operability is improved.

Furthermore, as shown in FIG. 7, a gripping portion 6g equipped with a rod-shaped main body portion 6g1 and a lock portion 6g2 may be provided, instead of the gripping portion 6e. A concentric penetration hole 6g3 is formed at one end portion of the main body portion 6g1. A diameter of the penetration hole 6g3 is slightly larger than the outer diameter of the base portion 61 of the tubular portion 6b, and the base portion 61 is inserted through the penetration hole 6g3. Further, a screw hole into which the lock portion 6g2 is screwed is formed at the end portion of the main body portion 6g1. The screw hole is connected to the penetration hole 6g3 from the radially outer side of the penetration hole 6g3. Therefore, the distal end portion of the lock portion 6g2 screwed into the screw hole can be brought into contact with the tubular portion 6b inserted into the penetration hole 6g3.

The lock portion 6g2 is a screw portion screwed into the aforementioned screw hole provided in the main body portion 6g1, and is moved in a direction along an axis thereof (the radial direction of the base portion 61 of the tubular portion 6b) by being rotated about the axis. As the lock portion 6g2 is rotated in a tightening direction (a direction in which the lock portion 6g2 moves to the radially inner side of the base portion 61 of the tubular portion 6b), the distal end portion of the lock portion 6g2 comes into contact with the base portion 61 of the tubular portion 6b, and regulates the movement of the main body portion 6g1 with respect to the base portion 61 by the frictional force.

The gripping portion 6g is movable along the extending direction (the longitudinal direction) of the base portion 61 of the tubular portion 6b by loosening the lock portion 6g2. Further, the gripping portion 6g is fixed to the tubular portion 6b by tightening the lock portion 6g2.

### Third Embodiment

Next, a third embodiment of the present disclosure will be described. In the third embodiment, the description of the same parts as those in the first embodiment will be omitted or simplified.

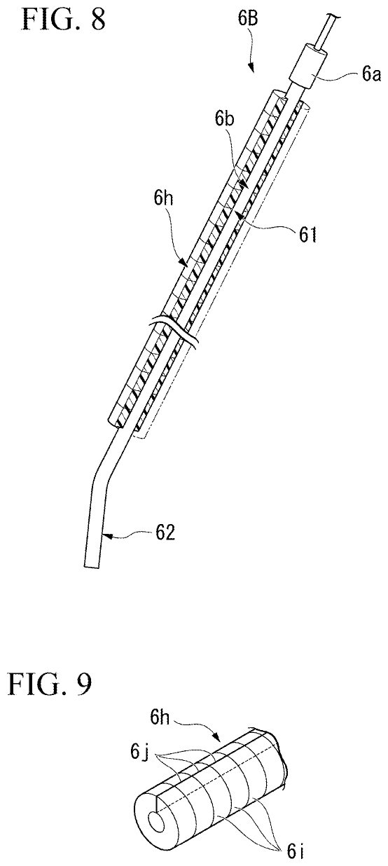

FIG. 8 is an enlarged perspective view showing a schematic configuration of a nozzle unit 6B of the present embodiment. As shown in FIG. 8, the nozzle unit 6B of the present embodiment is equipped with a heat insulating portion 6h, in addition to the configuration of the nozzle unit 6 of the first embodiment.

The heat insulating portion 6h is fixed to the tubular portion 6b to cover the periphery of the base portion 61 of the tubular portion 6b. That is, the nozzle unit 6B of the present embodiment has the heat insulating portion 6h which is fixed to the tubular portion 6b and covers the flow path R from the radially outer side. The heat insulating portion 6h prevents cold heat of the liquid nitrogen flowing through the flow path R of the tubular portion 6b from reaching the operator, and is formed of, for example, a foamed plastic material.

FIG. 9 is a partially enlarged perspective view showing a schematic configuration of the heat insulating portion 6h provided in the nozzle unit 6B of the present embodiment. As shown in FIG. 9, the heat insulating portion 6h is constituted by a plurality of heat insulating blocks 6i arranged continuously in the extending direction of the tubular portion 6b. Each heat insulating block 6i has an annular shape having a central opening through which the tubular portion 6b is inserted, and has a slit 6j extending from the outer peripheral surface thereof to the central opening. The slit 6j is a part through which the tubular portion 6b passes when the heat insulating block 6i is attached to and detached from the tubular portion 6b. The slit 6j can be expanded by elastically deforming the heat insulating block 6i, and can pass through the tubular portion 6b in the expanded state.

According to the nozzle unit 6B of the present embodiment, by attaching and detaching the heat insulating blocks 6i, it is possible to change a range in which the heat insulating portion 6h covers the tubular portion 6b. That is, according to the nozzle unit 6B of the present embodiment, the heat insulating portion 6h can be divided in the extending direction of the tubular portion 6b. Therefore, for example, when a concrete structure is drilled by the nozzle unit 6B, it is possible to change the shape of the heat insulating portion 6h so that the concrete structure and the heat insulating block 6i do not interfere with each other.

Although the preferred embodiment of the present disclosure has been described with reference to the drawings, the present disclosure is not limited to the aforementioned embodiments. The shapes, combinations, and the like of the constituent members shown in the aforementioned embodiments are merely examples, and can be variously changed on the basis of design requirements and the like, without departing from the spirit of the present disclosure.

For example, the configuration in which the nozzle unit 6 or the like is used for processing (chipping or drilling) a concrete structure including a reinforcing bar or a pipe has been described in the above-described embodiment. However, the present disclosure is not limited thereto. For example, the nozzle unit 6 or the like may be used for peeling a lining material of a concrete structure or a pipe, which has been lining-treated, from a base material. In this case, liquid nitrogen is injected from the nozzle unit 6 or the like into a part of the lining material to form a hole, and liquid nitrogen is injected between the lining material and the base material from the hole by the nozzle unit 6 or the like. Here, the injected liquid nitrogen is evaporated and expanded, and the lining material can be peeled from the base material by the expansion force.

Further, the configuration using liquid nitrogen as the liquefied fluid has been described in the aforementioned embodiment. However, the present disclosure is not limited thereto. For example, liquid carbon dioxide or liquid helium may be used as the liquefied fluid.

Further, the configuration in which the distal end portion 62 of the tubular portion 6b is curved and connected to the base portion 61 has been described in the aforementioned embodiment. However, the present disclosure is not limited thereto, and the distal end portion 62 may be bent and connected to the base portion 61 in the tubular portion 6b.

According to the present disclosure, it is possible to easily perform processing of a porous structure including inclusions such as a reinforcing bar or a pipe by a nozzle unit that injects a liquefied fluid that evaporates after being injected.

What is claimed is:

1. A nozzle unit which is configured to inject a liquefied fluid which evaporates after injection, the nozzle unit comprising:
a tubular portion which has a base portion and a distal end portion and in which a flow path configured to guide the liquefied fluid to a part including the distal end portion and the base portion is formed, the distal end portion having an injection opening and being bent or curved and connected to the base portion.

2. The nozzle unit according to claim 1, wherein:
the base portion is formed in a straight tube shape; and
the distal end portion is configured to inject the liquefied fluid in a direction inclined with respect to an axis of the base portion.

3. The nozzle unit according to claim 2, wherein the injection opening of the distal end portion opens toward a side opposite to the base portion.

4. The nozzle unit according to claim 1, further comprising a heat insulating portion which is fixed to the tubular portion and surrounds the flow path from a radially outer side.

5. The nozzle unit according to claim 4, wherein the heat insulating portion covers the tubular portion from the radially outer side, and is capable of being divided in an extending direction of the tubular portion.

6. The nozzle unit according to claim 1, further comprising a gripping portion which is attached to the tubular portion and protrudes to a radially outer side from the tubular portion.

7. The nozzle unit according to claim 6, wherein the gripping portion includes a plurality of gripping portions which are provided on the base portion to be spaced apart from each other in an extending direction of the flow path.

8. The nozzle unit according to claim 7, wherein the plurality of gripping portions protrude in different directions around the tubular portion.

9. The nozzle unit according to claim 6, wherein the gripping portion is attached to be movable in an extending direction of the tubular portion.
